(19) United States
(12) Patent Application Publication
(10) Pub. No.: US 2022/0142074 A1
(43) Pub. Date: May 12, 2022

(54) INDOOR GARDEN CENTER WITH A PISTON-OPERATED HYDRATION SYSTEM

(71) Applicant: Haier US Appliance Solutions, Inc., Wilmington, DE (US)

(72) Inventors: Brian Allgeier, Louisville, KY (US); Matthew R. Hunter, Louisville, KY (US)

(21) Appl. No.: 17/093,714

(22) Filed: Nov. 10, 2020

(51) Int. Cl. A01G 31/06; F04B 15/00; B05B 7/04

(52) U.S. Cl. CPC A01G 31/06; A01G 7/045; B05B 7/0408; F04B 15/00

(57) ABSTRACT

An indoor gardening appliance includes a grow module that is rotatably mounted within a grow chamber and that defines pod apertures for receiving a plurality of plant pods. A hydration system includes a nozzle assembly for selectively discharging a nutrient mixture from a mixing tank to hydrate plants within the grow chamber. The nozzle assembly includes a hydraulic cylinder including a piston positioned within a cylindrical chamber. An actuator moves the piston to a fully retracted position to draw in enough nutrient mixture for a single hydration cycle and then moves to a fully extended position to discharge the nutrient mixture. An intake check valve prevents undesirable backflow into the mixing tank and a discharge check valve prevents undesirable backflow into the cylindrical chamber.

### FIELD OF THE INVENTION

The present subject matter relates generally to systems for gardening plants indoors, and more particularly, to a system and method for regulating the hydration of plants in a garden center using a piston pump.

### BACKGROUND OF THE INVENTION

Conventional indoor garden centers include a cabinet defining a grow chamber having a number of trays or racks positioned therein to support seedlings or plant material, e.g., for growing herbs, vegetables, or other plants in an indoor environment. In addition, such indoor garden centers may include an environmental control system that maintains the growing chamber at a desired temperature or humidity. Certain indoor garden centers may also include hydration systems for watering the plants and/or artificial lighting systems that provide the light necessary for such plants to grow.

Conventional hydration systems for indoor gardens centers provide a flow of water and nutrients onto plants stored therein to facilitate plant growth. Specifically, typical hydration systems utilize a pump and accumulator combination for maintaining sufficient pressure to facilitate hydration cycles. In this regard, the pump pressurizes water within a bladder of the accumulator and then shuts off at a set point pressure. As water is discharged from the bladder to hydrate the plants, the pressure slowly decreases until the pump must re-pressurize the bladder. As a result, accumulator pressure often varies with time such that the quality of mist cycles may be inconsistent. In addition, inconsistent accumulator pressure may result in inaccurate hydration volumes and droplet sizes, which subsequently affects the uptake of the nutrient mixture by the plant roots. In addition, pumps used in such a pump/accumulator set up often must generate very high pressures, draw excessive amounts of power, and are very noisy.

Accordingly, an improved indoor garden center would be useful. More particularly, an indoor garden center with a hydration system that facilitates simple, constant pressure for improved hydration cycles would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a gardening appliance is provided including a liner positioned within a cabinet and defining a grow chamber, a grow module mounted within the liner and defining a pod aperture, the pod aperture being configured for receiving a plant pod, a mixing tank containing a nutrient mixture, and a nozzle assembly for selectively spraying the nutrient mixture into the grow chamber. The nozzle assembly includes a discharge nozzle positioned within the grow chamber, a hydraulic cylinder including an intake in fluid communication with the mixing tank and a discharge port in fluid communication with the discharge nozzle, and an actuator for selectively actuating the hydraulic cylinder to spray the nutrient mixture out of the discharge nozzle.

In another exemplary embodiment, a nozzle assembly for a gardening appliance is provided. The gardening appliance includes a grow chamber and a mixing tank containing a nutrient mixture. The nozzle assembly includes a discharge nozzle positioned within the grow chamber, a hydraulic cylinder including an intake in fluid communication with the mixing tank and a discharge port in fluid communication with the discharge nozzle, and an actuator for selectively actuating the hydraulic cylinder to spray the nutrient mixture out of the discharge nozzle.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a gardening appliance according to an exemplary embodiment of the present subject matter.

FIG. 2 depicts a front view of the exemplary gardening appliance of FIG. 1 with the doors open according to an exemplary embodiment of the present subject matter.

FIG. 3 is a cross sectional view of the exemplary gardening appliance of FIG. 1, taken along Line 3-3 from FIG. 2 with an internal divider removed for clarity.

FIG. 4 is a top perspective view of the exemplary gardening appliance of FIG. 1, with the top panel of the cabinet removed to reveal a rotatable grow module according to an exemplary embodiment of the present subject matter.

FIG. 5 provides a perspective cross sectional view of the exemplary gardening appliance of FIG. 1 according to another exemplary embodiment of the present subject matter.

FIG. 6 provides a perspective view of the grow module of the exemplary gardening appliance of FIG. 1 according to another exemplary embodiment of the present subject matter.

FIG. 7 provides a perspective cross sectional view of the exemplary grow module of FIG. 6 according to another exemplary embodiment of the present subject matter.

FIG. 8 provides a top cross-sectional view of the exemplary grow module of FIG. 6 according to another exemplary embodiment of the present subject matter.

FIG. 9 provides a perspective view of a hydration system that may be used with the exemplary gardening appliance of FIG. 1 according to an exemplary embodiment of the present subject matter.

FIG. 10 provides a schematic view of a nozzle assembly in an extended position according to an exemplary embodiment of the present subject matter.

FIG. 11 provides a schematic view of the exemplary nozzle assembly of FIG. 10 in a retracted position according to an exemplary embodiment of the present subject matter.

FIG. 12 provides a schematic view of another nozzle assembly according to an exemplary embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “approximately,” “substantially,” or “about,” refer to being within a ten percent (10%) margin of error of the stated value. Moreover, as used herein, the terms “first,” “second,” and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

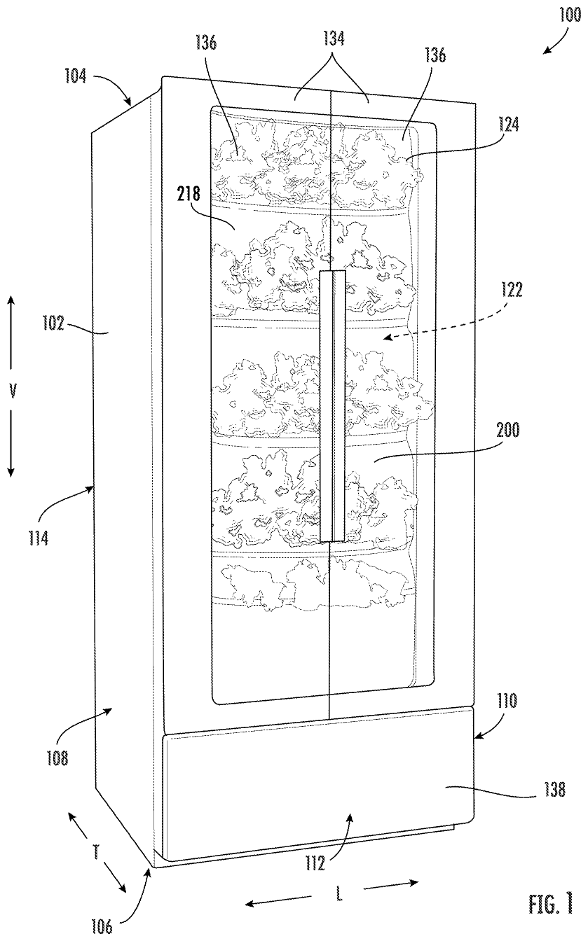

FIG. 1 provides a front view of a gardening appliance 100 according to an exemplary embodiment of the present subject matter. According to exemplary embodiments, gardening appliance 100 may be used as an indoor garden center for growing plants. It should be appreciated that the embodiments described herein are intended only for explaining aspects of the present subject matter. Variations and modifications may be made to gardening appliance 100 while remaining within the scope of the present subject matter.

Gardening appliance 100 includes a housing or cabinet 102 that extends between a top 104 and a bottom 106 along a vertical direction V, between a first side 108 and a second side 110 along a lateral direction L, and between a front side 112 and a rear side 114 along a transverse direction T. Each of the vertical direction V, lateral direction L, and transverse direction T are mutually perpendicular to one another and form an orthogonal direction system.

Gardening appliance 100 may include an insulated liner 120 positioned within cabinet 102. Liner 120 may at least partially define a temperature controlled, referred to herein generally as a grow chamber 122, within which plants 124 may be grown. Although gardening appliance 100 is referred to herein as growing plants 124, it should be appreciated that other organisms or living things may be grown or stored in gardening appliance 100. For example, algae, fungi (e.g., including mushrooms), or other living organisms may be grown or stored in gardening appliance 100. The specific application described herein is not intended to limit the scope of the present subject matter.

Cabinet 102, or more specifically, liner 120 may define a substantially enclosed back region or portion 130. In addition, cabinet 102 and liner 120 may define a front opening, referred to herein as front display opening 132, through which a user of gardening appliance 100 may access grow chamber 122, e.g., for harvesting, planting, pruning, or otherwise interacting with plants 124. According to an exemplary embodiment, enclosed back portion 130 may be defined as a portion of liner 120 that defines grow chamber 122 proximate rear side 114 of cabinet 102. In addition, front display opening 132 may generally be positioned proximate or coincide with front side 112 of cabinet 102.

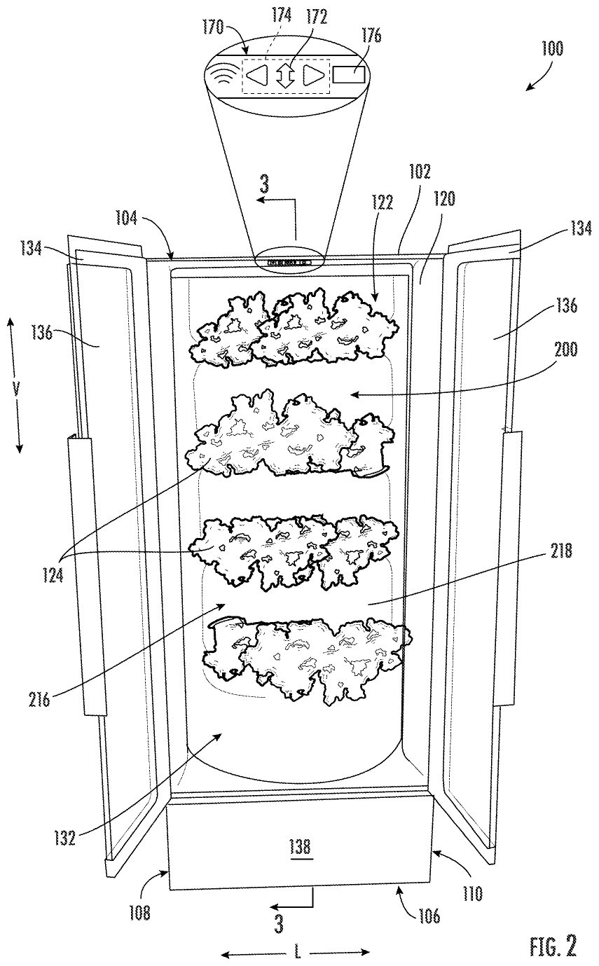

Gardening appliance 100 may further include one or more doors 134 that are rotatably mounted to cabinet 102 for providing selective access to grow chamber 122. For example, FIG. 1 illustrates doors 134 in the closed position such that they may help insulate grow chamber 122. By contrast, FIG. 2 illustrates doors 134 in the open positioned for accessing grow chamber 122 and plants 124 stored therein. Doors 134 may further include a transparent window 136 through which a user may observe plants 124 without opening doors 134.

Although doors 134 are illustrated as being rectangular and being mounted on front side 112 of cabinet 102 in FIGS. 1 and 2, it should be appreciated that according to alternative embodiments, doors 134 may have different shapes, mounting locations, etc. For example, doors 134 may be curved, may be formed entirely from glass, etc. In addition, doors 134 may have integral features for controlling light passing into and/or out of grow chamber 122, such as internal louvers, tinting, UV treatments, polarization, etc. One skilled in the art will appreciate that other chamber and door configurations are possible and within the scope of the present invention.

According to the illustrated embodiment, cabinet 102 further defines a drawer 138 positioned proximate bottom 106 of cabinet 102 and being slidably mounted to cabinet for providing convenient storage for plant nutrients, system accessories, water filters, etc. In addition, behind drawer 138 is a mechanical compartment 140 for receipt of an environmental control system including a sealed system for regulating the temperature within grow chamber 122, as described in more detail below.

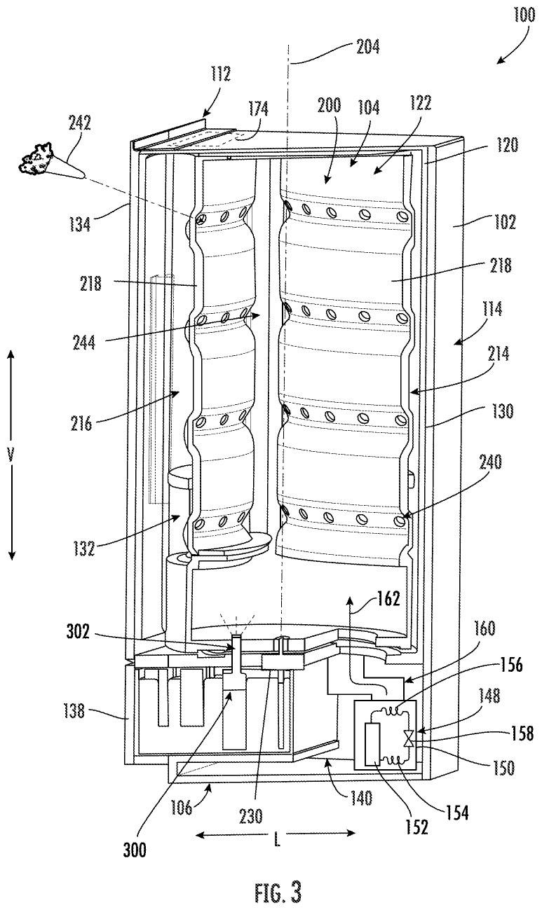

FIG. 3 provides a schematic view of certain components of an environmental control system 148 that may be used to regulate a temperature within grow chamber 122. Specifically, environmental control system 148 may include a sealed system 150, a duct system 160, and a hydration system 300, or any other suitable components or subsystems for regulating an environment within grow chamber 122, e.g., for facilitating improved or regulated growth of plants 124 positioned therein. Specifically, FIG. 3 illustrates sealed system 150 within mechanical compartment 140. Although an exemplary sealed system is illustrated and described herein, it should be appreciated that variations and modifications may be made to sealed system 150 while remaining within the scope of the present subject matter. For example, sealed system 150 may include additional or alternative components, different ducting configurations, etc.

As shown, sealed system 150 includes a compressor 152, a first heat exchanger or evaporator 154 and a second heat exchanger or condenser 156. As is generally understood, compressor 152 is generally operable to circulate or urge a flow of refrigerant through sealed system 150, which may include various conduits which may be utilized to flow refrigerant between the various components of sealed system 150. Thus, evaporator 154 and condenser 156 may be between and in fluid communication with each other and compressor 152.

During operation of sealed system 150, refrigerant flows from evaporator 154 and to compressor 152, and compressor 152 is generally configured to direct compressed refrigerant from compressor 152 to condenser 156. For example, refrigerant may exit evaporator 154 as a fluid in the form of a superheated vapor. Upon exiting evaporator 154, the refrigerant may enter compressor 152, which is operable to compress the refrigerant. Accordingly, the pressure and temperature of the refrigerant may be increased in compressor 152 such that the refrigerant becomes a more superheated vapor.

Condenser 156 is disposed downstream of compressor 152 and is operable to reject heat from the refrigerant. For example, the superheated vapor from compressor 152 may enter condenser 156 and transfer energy to air surrounding condenser 156 (e.g., to create a flow of heated air). In this manner, the refrigerant condenses into a saturated liquid and/or liquid vapor mixture. A condenser fan (not shown) may be positioned adjacent condenser 156 and may facilitate or urge the flow of heated air across the coils of condenser 156 (e.g., from ambient atmosphere) in order to facilitate heat transfer.

According to the illustrated embodiment, an expansion device or a variable electronic expansion valve 158 may be further provided to regulate refrigerant expansion. During use, variable electronic expansion valve 158 may generally expand the refrigerant, lowering the pressure and temperature thereof. In this regard, refrigerant may exit condenser 156 in the form of high liquid quality/saturated liquid vapor mixture and travel through variable electronic expansion valve 158 before flowing through evaporator 154. Variable electronic expansion valve 158 is generally configured to be adjustable, e.g., such that the flow of refrigerant (e.g., volumetric flow rate in milliliters per second) through variable electronic expansion valve 158 may be selectively varied or adjusted.

Evaporator 154 is disposed downstream of variable electronic expansion valve 158 and is operable to heat refrigerant within evaporator 154, e.g., by absorbing thermal energy from air surrounding the evaporator (e.g., to create a flow of cooled air). For example, the liquid or liquid vapor mixture refrigerant from variable electronic expansion valve 158 may enter evaporator 154. Within evaporator 154, the refrigerant from variable electronic expansion valve 158 receives energy from the flow of cooled air and vaporizes into superheated vapor and/or high quality vapor mixture. An air handler or evaporator fan (not shown) is positioned adjacent evaporator 154 and may facilitate or urge the flow of cooled air across evaporator 154 in order to facilitate heat transfer. From evaporator 154, refrigerant may return to compressor 152 and the vapor-compression cycle may continue.

As explained above, environmental control system 148 includes a sealed system 150 for providing a flow of heated air or a flow cooled air throughout grow chamber 122 as needed. To direct this air, environmental control system 148 includes a duct system 160 for directing the flow of temperature regulated air, identified herein simply as flow of air 162 (see, e.g., FIG. 3). In this regard, for example, an evaporator fan can generate a flow of cooled air as the air passes over evaporator 154 and a condenser fan can generate a flow of heated air as the air passes over condenser 156.

These flows of air 162 are routed through a cooled air supply duct and/or a heated air supply duct (not shown), respectively. In this regard, it should be appreciated that environmental control system 148 may generally include a plurality of ducts, dampers, diverter assemblies, and/or air handlers to facilitate operation in a cooling mode, in a heating mode, in both a heating and cooling mode, or any other mode suitable for regulating the environment within grow chamber 122. It should be appreciated that duct system 160 may vary in complexity and may regulate the flows of air from sealed system 150 in any suitable arrangement through any suitable portion of grow chamber 122.

Gardening appliance 100 may include a control panel 170. Control panel 170 includes one or more input selectors 172, such as e.g., knobs, buttons, push buttons, touchscreen interfaces, etc. In addition, input selectors 172 may be used to specify or set various settings of gardening appliance 100, such as e.g., settings associated with operation of sealed system 150. Input selectors 172 may be in communication with a processing device or controller 174. Control signals generated in or by controller 174 operate gardening appliance 100 in response to input selectors 172. Additionally, control panel 170 may include a display 176, such as an indicator light or a screen. Display 176 is communicatively coupled with controller 174 and may display information in response to signals from controller 174. Further, as will be described herein, controller 174 may be communicatively coupled with other components of gardening appliance 100, such as e.g., one or more sensors, motors, or other components.

As used herein, “processing device” or “controller” may refer to one or more microprocessors or semiconductor devices and is not restricted necessarily to a single element. The processing device can be programmed to operate gardening appliance 100. The processing device may include, or be associated with, one or more memory elements (e.g., non-transitory storage media). In some such embodiments, the memory elements include electrically erasable, programmable read only memory (EEPROM). Generally, the memory elements can store information accessible processing device, including instructions that can be executed by processing device. Optionally, the instructions can be software or any set of instructions and/or data that when executed by the processing device, cause the processing device to perform operations.

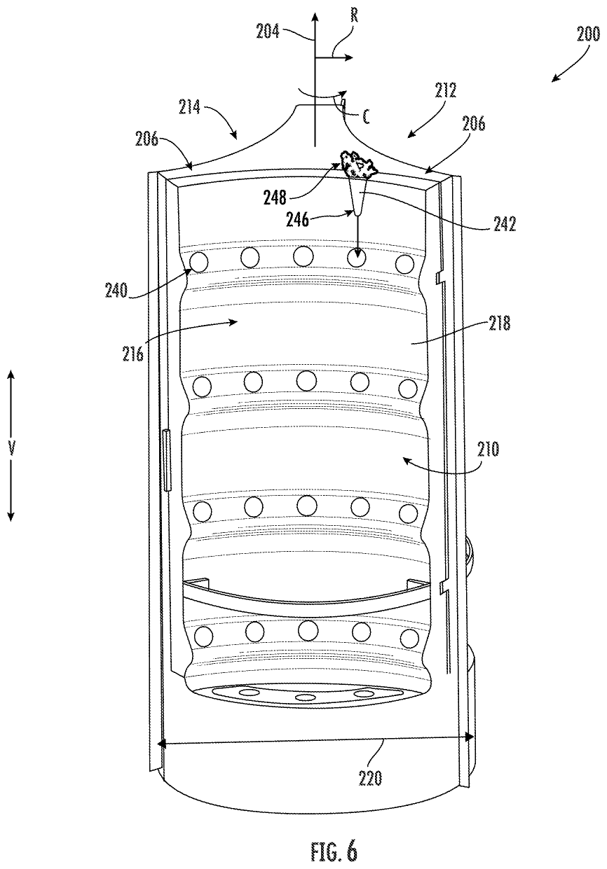

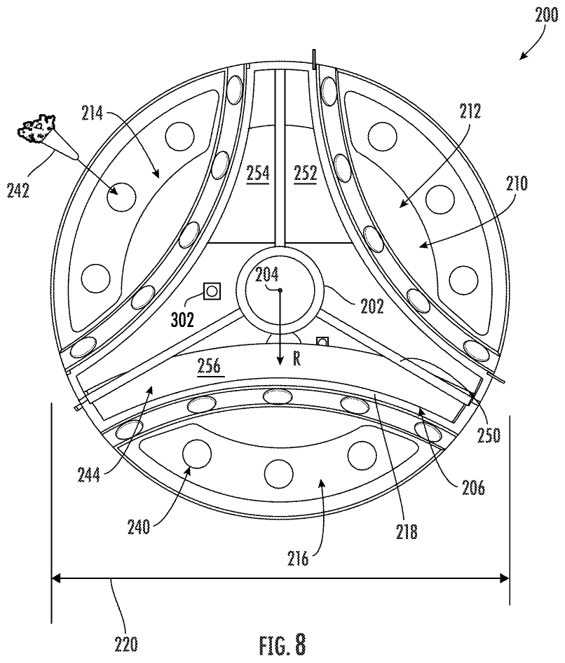

Referring now generally to FIGS. 1 through 8, gardening appliance 100 generally includes a rotatable carousel, referred to herein as a grow module 200 that is mounted within liner 120, e.g., such that it is within grow chamber 122. As illustrated, grow module 200 includes a central hub 202 that extends along and is rotatable about a central axis 204. Specifically, according to the illustrated embodiment, central axis 204 is parallel to the vertical direction V. However, it should be appreciated that central axis 204 could alternatively extend in any suitable direction, e.g., such as the horizontal direction. In this regard, grow module 200 generally defines an axial direction, i.e., parallel to central axis 204, a radial direction R that extends perpendicular to central axis 204, and a circumferential direction C that extends around central axis 204 (e.g. in a plane perpendicular to central axis 204).

Grow module 200 may further include a plurality of partitions 206 that extend from central hub 202 substantially along the radial direction R. In this manner, grow module 200 defines a plurality of chambers, referred to herein generally by reference numeral 210, by dividing or partitioning grow chamber 122. Referring specifically to a first embodiment of grow module 200 illustrated in FIGS. 1 through 8, grow module 200 includes three partitions 206 to define a first chamber 212, a second chamber 214, and a third chamber 216, which are circumferentially spaced relative to each other. In general, as grow module 200 is rotated within grow chamber 122, the plurality of chambers 210 define substantially separate and distinct growing environments, e.g., for growing plants 124 having different growth needs.

More specifically, partitions 206 may extend from central hub 202 to a location immediately adjacent liner 120. Although partitions 206 are described as extending along the radial direction, it should be appreciated that they need not be entirely radially extending. For example, according to the illustrated embodiment, the distal ends of each partition is joined with an adjacent partition using an arcuate wall 218, which is generally used to support plants 124.

Notably, it is desirable according to exemplary embodiments to form a substantial seal between partitions 206 and liner 120. Therefore, according to an exemplary embodiment, grow module 200 may define a grow module diameter 220 (e.g., defined by its substantially circular footprint formed in a horizontal plane). Similarly, enclosed back portion 130 of liner 120 may be substantially cylindrical and may define a liner diameter 222. In order to prevent a significant amount of air from escaping between partitions 206 and liner 120, liner diameter 222 may be substantially equal to or slightly larger than grow module diameter 220.

Referring now specifically to FIG. 3, gardening appliance 100 may further include a motor 230 or another suitable driving element or device for selectively rotating grow module 200 during operation of gardening appliance 100. In this regard, according to the illustrated embodiment, motor 230 is positioned below grow module 200, e.g., within mechanical compartment 140, and is operably coupled to grow module 200 along central axis 204 for rotating grow module 200.

As used herein, “motor” may refer to any suitable drive motor and/or transmission assembly for rotating grow module 200. For example, motor 230 may be a brushless DC electric motor, a stepper motor, or any other suitable type or configuration of motor. For example, motor 230 may be an AC motor, an induction motor, a permanent magnet synchronous motor, or any other suitable type of AC motor. In addition, motor 230 may include any suitable transmission assemblies, clutch mechanisms, or other components.

According to an exemplary embodiment, motor 230 may be operably coupled to controller 174, which is programmed to rotate grow module 200 according to predetermined operating cycles, based on user inputs (e.g. via touch buttons 172), etc. In addition, controller 174 may be communicatively coupled to one or more sensors, such as temperature or humidity sensors, positioned within the various chambers 210 for measuring temperatures and/or humidity, respectively. Controller 174 may then operate motor 230 in order to maintain desired environmental conditions for each of the respective chambers 210. For example, as will be described in more detail below, gardening appliance 100 includes features for providing certain locations of gardening appliance 100 with light, temperature control, proper moisture, nutrients, and other requirements for suitable plant growth. Motor 230 may be used to position specific chambers 210 where needed to receive such growth requirements.

According to an exemplary embodiment, such as where three partitions 206 form three chambers 212-216, controller 174 may operate motor 230 to index grow module 200 sequentially through a number of preselected positions. More specifically, motor 230 may rotate grow module 200 in a counterclockwise direction (e.g. when viewed from a top of grow module 200) in 120° increments to move chambers 210 between sealed positions and display positions. As used herein, a chamber 210 is considered to be in a “sealed position” when that chamber 210 is substantially sealed between grow module 200 (i.e., central hub 202 and adjacent partitions 206) and liner 120. By contrast, a chamber 210 is considered to be in a “display position” when that chamber 210 is at least partially exposed to front display opening 132, such that a user may access plants 124 positioned within that chamber 210.

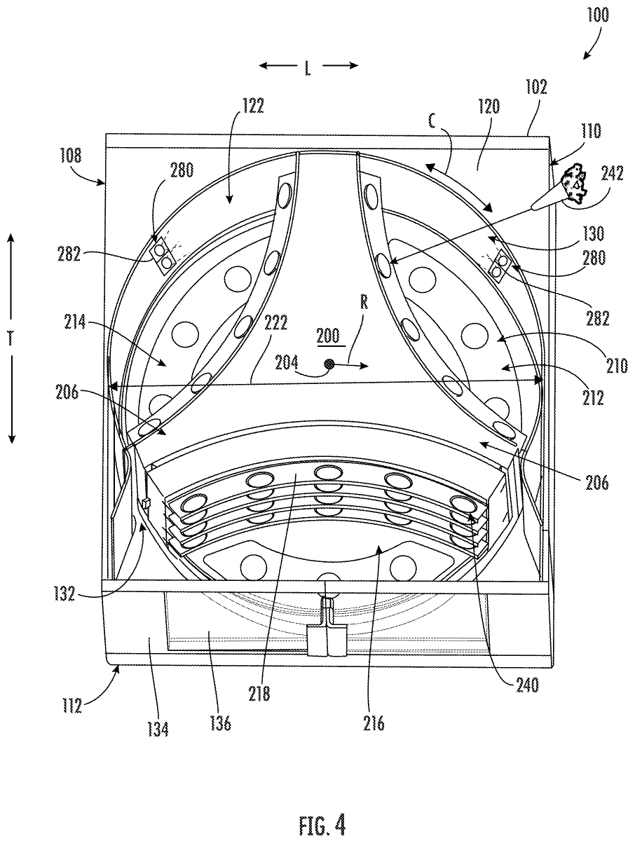

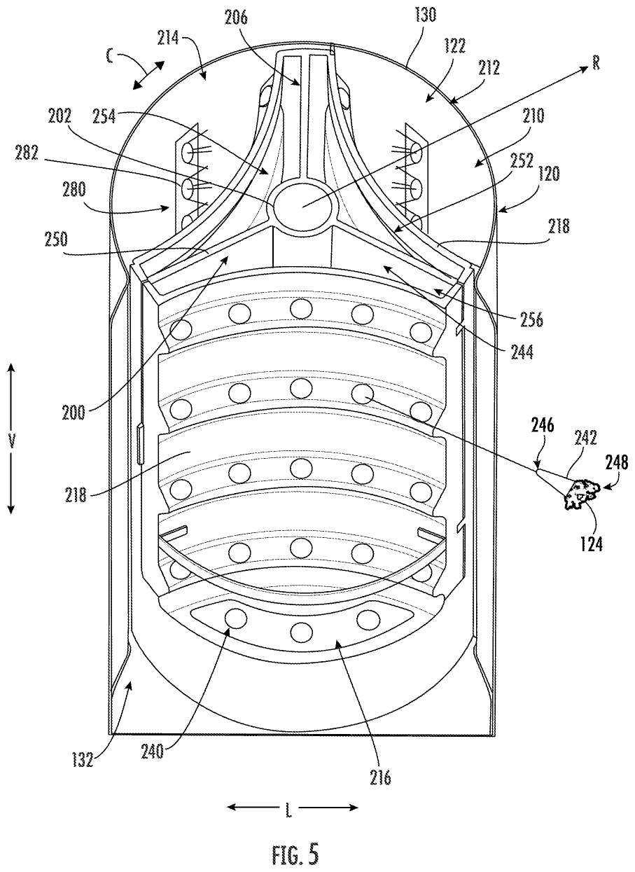

For example, as illustrated in FIGS. 4 and 5, first chamber 212 and second chamber 214 are both in a sealed position, whereas third chamber 216 is in a display position. As motor 230 rotates grow module 200 by 120 degrees in the counterclockwise direction, second chamber 214 will enter the display position, while first chamber 212 and third chamber 216 will be in the sealed positions. Motor 230 may continue to rotate grow module 200 in such increments to cycle grow chambers 210 between these sealed and display positions.

Referring now generally to FIGS. 4 through 8, grow module 200 will be described in more detail according to an exemplary embodiment of the present subject matter. As shown, grow module 200 defines a plurality of apertures 240 which are generally configured for receiving plant pods 242 into an internal root chamber 244. Plant pods 242 generally contain seedlings or other material for growing plants positioned within a mesh or other support structure through which roots of plants 124 may grow within grow module 200. A user may insert a portion of plant pod 242 (e.g., a seed end or root end 246) having the desired seeds through one of the plurality of apertures 240 into root chamber 244. A plant end 248 of the plant pod 242 may remain within grow chamber 210 such that plants 124 may grow from grow module 200 such that they are accessible by a user. In this regard, grow module 200 defines root chamber 244, e.g., within at least one of central hub 202 and the plurality of partitions 206. As will be explained below, water and other nutrients may be supplied to the root end 246 of plant pods 242 within root chamber 244. Notably, apertures 240 may be covered by a flat flapper seal (not shown) to prevent water from escaping root chamber 244 when no plant pod 242 is installed.

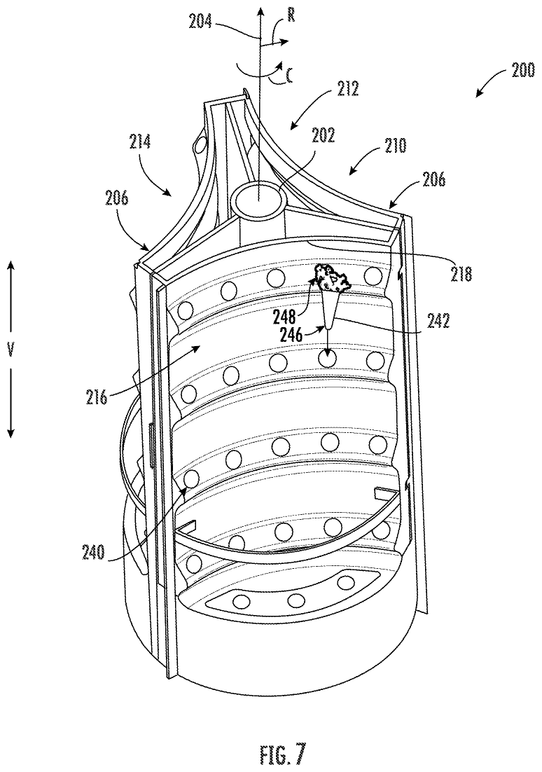

As best shown in FIGS. 5 and 7, grow module 200 may further include an internal divider 250 that is positioned within root chamber 244 to divide root chamber 244 into a plurality of root chambers, each of the plurality of root chambers being in fluid communication with one of the plurality of grow chambers 210 through the plurality of apertures 240. More specifically, according to the illustrated embodiment, internal divider 250 may divide root chamber 244 into a first root chamber 252, a second root chamber 254, and a third root chamber 256. According to an exemplary embodiment, first root chamber 252 may provide water and nutrients to plants 124 positioned in the first grow chamber 212, second root chamber 254 may provide water and nutrients to plants 124 positioned in the second grow chamber 214, and third root chamber 256 may provide water and nutrients to plants 124 positioned in the third grow chamber 216. In this manner, environmental control system 148 may control the temperature and/or humidity of each of the plurality of chambers 212-216 and the plurality of root chambers 252-256 independently of each other.

Notably, environmental control system 148 described above is generally configured for regulating the temperature and humidity (e.g., or some other suitable water level quantity or measurement) within one or all of the plurality of chambers 210 and/or root chambers 252-256 independently of each other. In this manner, a versatile and desirable growing environment may be obtained for each and every chamber 210.

Referring now for example to FIGS. 4 and 5, gardening appliance 100 may further include a light assembly 280 which is generally configured for providing light into selected grow chambers 210 to facilitate photosynthesis and growth of plants 124. As shown, light assembly 280 may include a plurality of light sources 282 stacked in an array, e.g., extending along the vertical direction V. For example, light sources 282 may be mounted directly to liner 120 within grow chamber 122, or may alternatively be positioned behind liner 120 such that light is projected through a transparent window or light pipe into grow chamber 122. The position, configuration, and type of light sources 282 described herein are not intended to limit the scope of the present subject matter in any manner.

Light sources 282 may be provided as any suitable number, type, position, and configuration of electrical light source(s), using any suitable light technology and illuminating in any suitable color. For example, according to the illustrated embodiment, light source 282 includes one or more light emitting diodes (LEDs), which may each illuminate in a single color (e.g., white LEDs), or which may each illuminate in multiple colors (e.g., multi-color or RGB LEDs) depending on the control signal from controller 174. However, it should be appreciated that according to alternative embodiments, light sources 282 may include any other suitable traditional light bulbs or sources, such as halogen bulbs, fluorescent bulbs, incandescent bulbs, glow bars, a fiber light source, etc.

As explained above, light generated from light assembly 280 may result in light pollution within a room where gardening appliance 100 is located. Therefore, aspects of the present subject matter are directed to features for reducing light pollution, or to the blocking of light from light sources 282 through front display opening 132. Specifically, as illustrated, light assembly 280 is positioned only within the enclosed back portion 130 of liner 120 such that only grow chambers 210 which are in a sealed position are exposed to light from light sources 282. Specifically, grow module 200 acts as a physical partition between light assemblies 280 and front display opening 132. In this manner, as illustrated in FIG. 5, no light may pass from first chamber 212 or second chamber 214 through grow module 200 and out front display opening 132. As grow module 200 rotates, two of the three grow chambers 210 will receive light from light assembly 280 at a time. According still other embodiments, a single light assembly may be used to reduce costs, whereby only a single grow chamber 210 will be lit at a single time.

Gardening appliance 100 and grow module 200 have been described above to explain an exemplary embodiment of the present subject matter. However, it should be appreciated that variations and modifications may be made while remaining within the scope of the present subject matter. For example, according to alternative embodiments, gardening appliance 100 may be a simplified to a two-chamber embodiment with a square liner 120 and a grow module 200 having two partitions 206 extending from opposite sides of central hub 202 to define a first grow chamber and a second grow chamber. According to such an embodiment, by rotating grow module 200 by 180 degrees about central axis 206, the first chamber may alternate between the sealed position (e.g., facing rear side 114 of cabinet 102) and the display position (e.g., facing front side 112 of cabinet 102). By contrast, the same rotation will move the second chamber from the display position to the sealed position.

According to still other embodiments, gardening appliance 100 may include a three chamber grow module 200 but may have a modified cabinet 102 such that front display opening 132 is wider and two of the three grow chambers 210 are displayed at a single time. Thus, first chamber 212 may be in the sealed position, while second chamber 214 and third chamber 216 may be in the display positions. As grow module 200 is rotated counterclockwise, first chamber 212 is moved into the display position and third chamber 216 is moved into the sealed position.

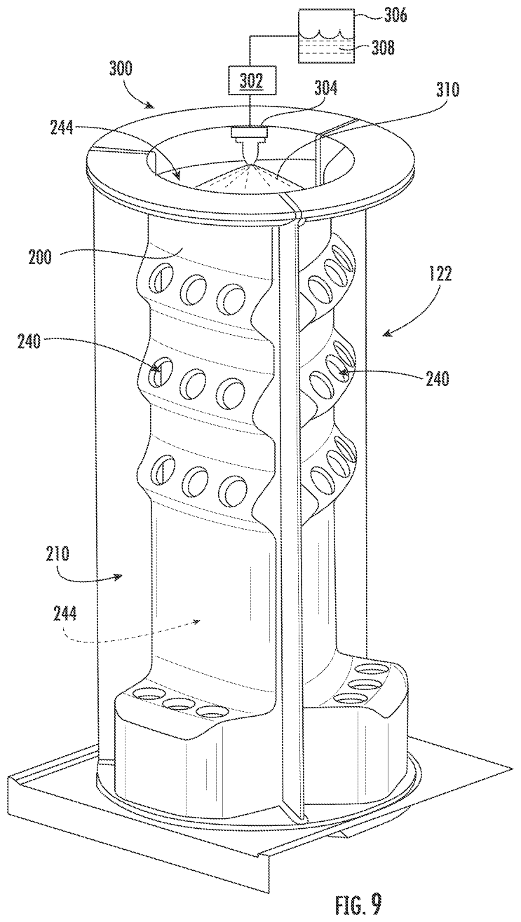

Referring now to FIG. 9, a hydration system 300 will be described according to an exemplary embodiment of the present subject matter. In general, hydration system 300 may be used to provide a mist or flow of nutrient rich liquid into grow chamber 122 to facilitate plant growth. For example, continuing the example from above, hydration system 300 may be a part or subsystem of environmental control system 148 of gardening appliance 100. Although hydration system 300 is described herein in the context of gardening appliance 100, it should be appreciated that aspects of the present subject matter may be used to provide hydration and/or nutrients to plants in any other gardening appliance or in any other application where it is desirable to selectively provide desirable quantities and concentrations of hydration, nutrients, and/or other fluids onto plants to facilitate improved plant growth.

FIG. 9 provides a schematic illustration of hydration system 300 to facilitate discussion of aspects of the present subject matter. However, it should be appreciated that variations and modifications may be made to hydration system 300 while remaining within the scope of the present subject matter. For example, grow module 200 may take any other form and may have any other suitable number and size of apertures. In addition, any other suitable size, number, and orientation of discharge nozzles may be used. Moreover, the plumbing configuration for providing flows of water, air, and/or nutrients to hydration system 300 may vary.

In general, hydration system 300 includes a nozzle assembly 302 for selectively discharging nutrients within grow chamber 122. For example, as illustrated in FIG. 9, nozzle assembly 302 includes a discharge nozzle 304 (e.g., such as a fine mist spray nozzle or nozzles) that is fluidly coupled to a water/nutrient supply, such as a mixing tank 306. According to the illustrated embodiment, mixing tank 306 is supplied with the desired mixture of water and/or nutrients (referred to herein generally as nutrient mixture 308) for optimal growth of plants 124. It should be appreciated that mixing tank 306 may itself be fluidly coupled to a water supply (not shown), such as a reservoir containing water (e.g., distilled water) or a municipal water supply. In addition, mixing tank 306 may be fluidly coupled to a nutrient dispensing assembly (not shown) that may be provide the desired amount or concentration of nutrients within mixing tank 306.

Nozzle assembly 302 is generally configured for receiving a flow of nutrient mixture 308 and generating a mist of nutrients (e.g., identified herein by reference numeral 310). Specifically, discharge nozzle 304 selectively discharges nutrients in a high pressure, atomized, and/or ionized mist with droplets that are optimally sized for root absorption. Any suitable type and configuration of nozzle may be used to generate a mist 310 containing droplets that are carefully sized to be small enough where the force of gravity is mostly offset by the viscous forces of the air and the droplets are more or less neutrally buoyant. In addition, these droplets may be optimally sized for easy uptake by the roots of the plants.

Discharge nozzle 304 may be positioned at any suitable location within grow chamber 122, such as at a top of root chamber 244 as shown in FIG. 9. Alternatively, hydration system 300 may include a plurality of discharge nozzles 304 spaced apart along the vertical direction V within each of root chambers 252-256. According to still other embodiments, hydration system 300 may include a discharge nozzle 304 positioned at a bottom of grow chamber 122, as shown for example in FIG. 3. According to exemplary embodiments, hydration system 300 may include any suitable number, type, and position of discharge nozzles 304 for improving the distribution of the mist of nutrients 310. It should be appreciated that discharge nozzle 304 is configured for generating the mist of nutrients 310 that includes a high pressure atomized and ionized fluid or mist including both water and/or nutrients. In this manner, discharge nozzle 304 charges root chamber 244 with mist 310 for hydrating the roots of plants 124.

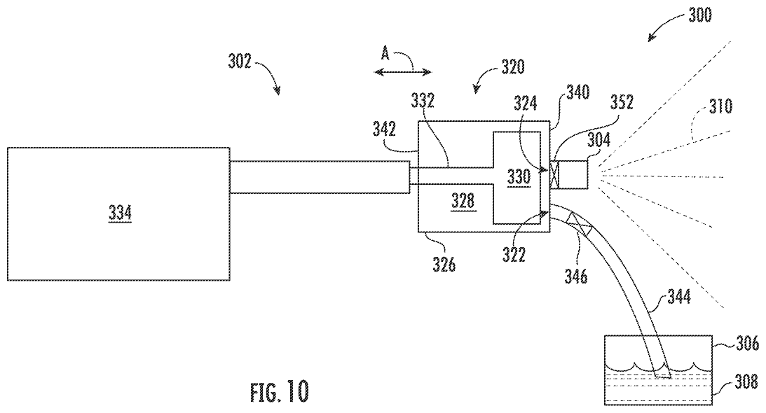

Referring now also to FIGS. 10 through 12, nozzle assemblies 302 that may be used with hydration system 300 and gardening appliance 100 will be described according to exemplary embodiments of the present subject matter. Due to the similarity between embodiments, like reference numerals may be used to refer to the same or similar features. Although exemplary components and plumbing configurations are described herein, it should be appreciated that variations and modifications may be made to nozzle assembly 302 while remaining within the scope of the present subject matter.

As shown, nozzle assembly 302 generally includes a hydraulic cylinder 320 that includes an intake 322 that is in fluid communication with mixing tank 306 and a discharge port 324 that is in fluid communication with discharge nozzle 304. Specifically, according to an exemplary embodiment, hydraulic cylinder 320 includes a barrel 326 defining a cylindrical chamber 328. A plunger or piston 330 is slidably mounted within cylindrical chamber 328 and is generally configured for drawing in or discharging nutrient mixture 308 from cylindrical chamber 328. In addition, nozzle assembly 302 may include a piston rod 332 that mechanically couples piston 330 to an actuator 334. Actuator 334 may be operably coupled with a controller, such as controller 174, which may selectively operate hydraulic cylinder 320 to facilitate the hydration process for gardening appliance 100. Each of these components will be described in more detail below according to exemplary embodiments.

As used herein, “actuator” is intended to refer to any device or mechanism suitable for moving piston 330 between an extended and a retracted position. For example, actuator 334 may be a pneumatic actuator that operates by regulating the flow of pressurized air from an air supply source (not shown). According to an alternative embodiment, actuator 334 may be a piezoelectric actuator that permits precise positioning of piston 330 in response to an electrical input. Other suitable actuators 334 are possible and within the scope of the present subject matter, such as linear actuators, hydraulic actuators, electric motor actuators, cam actuators, etc. Indeed, actuator 334 may be any device or mechanism suitable for charging a cylinder with a nutrient mixture and discharging that mixture through a discharge nozzle to create a mist of nutrients for hydrating plants 124.

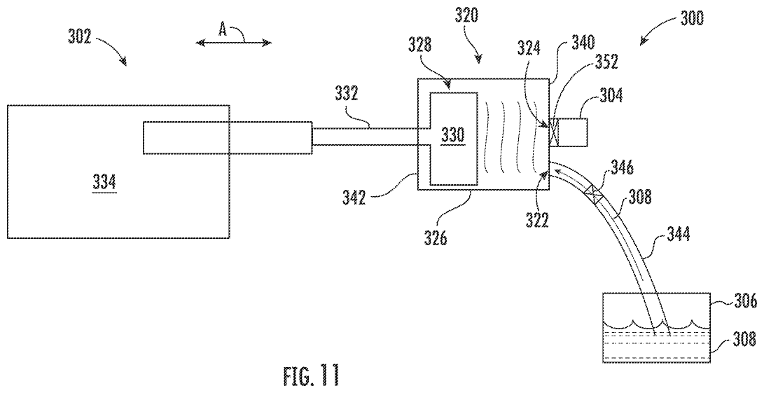

In general, during operation, nozzle assembly 302 may fill cylindrical chamber 328 with the nutrient mixture 308 for a hydration cycle. This filling process may be referred to herein as a “recharge” operation or the like. In this regard, during a recharge operation, actuator 334 moves piston 330 from an extended position (e.g., as shown in FIG. 10) to a retracted position (e.g., as shown in FIG. 11). This movement of piston 330 within cylindrical chamber 328 creates a negative pressure that draws a flow of nutrient mixture 308 from mixing tank 306 into cylindrical chamber 328. After cylindrical chamber 328 is filled or recharged with nutrient mixture 308, actuator 334 may slide piston 330 back toward the extended position to discharge the nutrient mixture 308 through discharge nozzle 304, thereby generating a mist of nutrients 310 for hydrating plants 124. This misting process may be referred to herein as a “discharge” operation or the like.

According to the illustrated embodiment, barrel 326 extends between a first end wall 340 (e.g., against which piston 330 is seated in the fully extended position) and a second end wall 342 (e.g., against which piston 330 is seated in the fully retracted position) that are separated along an axial direction A. As shown, intake 322 of hydraulic cylinder 320 may be a port defined in first end wall 340 of barrel 326. In addition, intake 322 is fluidly coupled to mixing tank 306 through an intake conduit 344. In addition, according to an exemplary embodiment of the present subject matter, nozzle assembly 302 may include an intake check valve 346 that is operably coupled to intake 322 or intake conduit 344 for preventing flow out of cylindrical chamber 328 through intake 322 during a discharge operation. In this regard, as piston 330 moves from the retracted to the extended position, it may be desirable that all of the resulting pressure generated is directed toward discharge port 324 and/or discharge nozzle 304 instead of back into mixing tank 306. Thus, for example, intake check valve 346 may be mounted directly to intake 322 for permitting passage of the flow of nutrient mixture 308 from mixing tank 306 into cylindrical chamber 328, while preventing the flow of nutrient mixture 308 in the reverse direction.

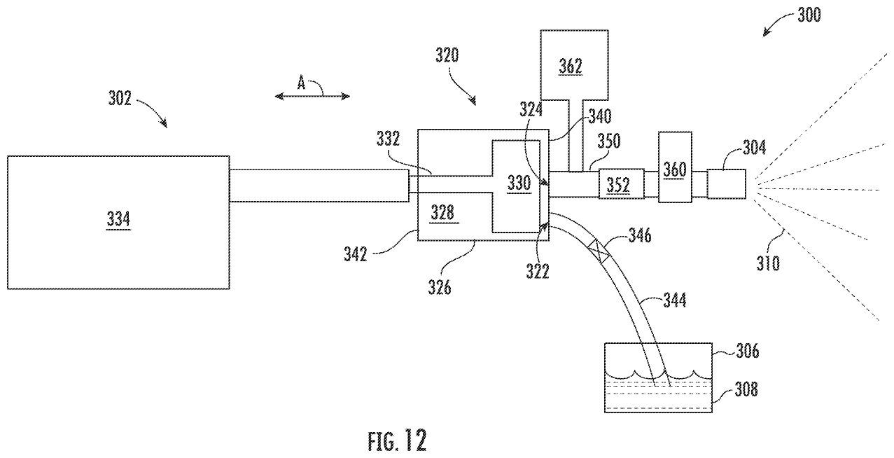

Similarly, discharge port 324 may be an aperture defined in the first end wall 340 that is directly fluidly coupled to discharge nozzle 304 (e.g., as shown in FIGS. 10 and 11) or which is otherwise fluidly coupled to discharge nozzle 304 through a discharge conduit 350 (FIG. 12). According to an exemplary embodiment, nozzle assembly 302 may further include a nozzle check valve 352 that is generally configured for preventing flow of nutrient mixture 308 from discharge nozzle 304 into cylindrical chamber 328 during a recharge operation. In this manner, as piston 330 slides toward second end wall 342 (i.e., the retracted position) during a recharge process, it may be desirable to only draw nutrient mixture 308 through intake 322 from mixing tank 306, while preventing the intake of air and/or nutrients 308 from discharge port 324.

It should be appreciated that intake check valve 346 and nozzle check valve 352 may be any suitable type and configuration of one-way valve that is generally intended to prevent flow in one direction. For example, check valves 346, 352 may be flapper valves, duckbill valves, slit valves, ball valves, piston valves, solenoid valves, or any other suitable type of valve. In addition, according to an exemplary embodiment, one or both of check valves 346, 352 may have a forward biased cracking pressure that prevents the flow of nutrient mixture 308 until a desired pressure (e.g., positive or negative) is generated. In this regard, the term “cracking pressure” is generally intended herein to refer to the pressure at which a check valve opens when it is forward biased, or when the pressure is motivating the flow in the permitted direction.

In this regard, for example, nozzle check valve 352 may include a cracking pressure that is suitable to raise the pressure of nutrient mixture 308 within cylindrical chamber 328 before discharge through discharge nozzle 304 occurs. This may be helpful, for example, to ensure sufficient atomization of the mist of nutrients 310 with minimal drips or conglomeration of fluid particles. In this regard, nozzle check valve 352 may have a cracking pressure that corresponds to a desired nozzle pressure, e.g., a nozzle pressure which establishes the ideal flow of mist of nutrients 310 from discharge nozzle 304. For example, according to an exemplary embodiment, nozzle check valve 352 may have a cracking pressure of between about 10 and 1000 pounds per square inch (“psi”), between about 30 and 700 psi, between about 50 and 500 psi, between about 100 and 300 psi, or about 150 psi. Notably, conventional check valves may have a cracking pressure of less than 5 psi, such as around about 1 psi. By including nozzle check valve 352 with an increased cracking pressure, sufficient chamber pressure may be achieved before discharging the mist of nutrients 310 through discharge nozzle 304, resulting in a better spray pattern, volume, etc.

Referring now specifically to FIG. 12, nozzle assembly 302 may include other features or devices for improving a hydration process within gardening appliance 100. For example, hydraulic cylinder 320 may be vulnerable to drawing air into the system. In this regard, for example, if check valves 346 and/or 352 do not create a perfect seal, if air bubbles are present within nutrient mixture 308, or if other air leaks are present, air may enter cylindrical chamber 328 during the recharge and/or discharge cycle. Notably, during a discharge process, piston 330 may compress air pockets before the nutrient mixture 308 is pressurized. This may result in repeatability and misting control issues.

In order to address such issues, nozzle check valve 352 (e.g., which may be positioned within discharge nozzle 304) may have an elevated cracking pressure relative to conventional valves, as discussed above. In this regard, for example, nozzle check valve 352 may generally be responsible for physically opening once the desired pressure is reached, e.g., to prevent misting flow through discharge nozzle 304 from occurring at pressures below an acceptable range.

In addition, according to an exemplary embodiment, nozzle check valve 352 may be located outside discharge nozzle 304. According to such an embodiment, nozzle assembly 302 may include a pressure switch 360 that is positioned between the cylindrical chamber and the discharge nozzle. The pressure switch may be configured for triggering when a pressure of the nutrient mixture exceeds a predetermined pressure, e.g., the desired misting pressure. According to an exemplary embodiment, pressure switch 360 is installed between nozzle check valve 352 and discharge nozzle 304, though other positions and configurations are possible. Pressure switch 360 may generally be configured for tripping or triggering once nozzle check valve 352 is open and the desired misting pressure has been reached, thereby initiating the misting process. Notably, when just nozzle check valve 352 is used, there is no way to sense when the desired pressure was reached. By including pressure switch 360, the exact moment when the desired pressure was reached may be known, which allows more accurate control over the timing of a misting cycle. In a situation where there is an air bubble within hydraulic cylinder 320, the pressure rise may be delayed while the bubble shrinks and gets dissolved into the nutrient mixture 308. This may lead to inaccurate (under-dosing) misting times in an implementation without pressure switch 360. With pressure switch 360, however, the misting timing will not begin until pressure switch 360 is triggered, thus allowing a full, accurate dose.

In addition, according to exemplary embodiments of the present subject matter, nozzle assembly 302 may include an air release valve 362 that is generally configured for purging air from within nozzle assembly 302. In this regard, air release valve 362 may be designed to bleed off air as piston 330 begins to pressurize cylindrical chamber 328. In this manner, troublesome air is discharged from nutrient mixture 308 within nozzle assembly 302 before the nutrient mixture 308 is passed through discharge nozzle 304. According to alternative embodiments, nozzle 302 may include other features, mechanisms, or devices for improving the intake of nutrient mixture 308 during a recharge cycle, the pressurization and discharge of nutrient mixture 308 during a discharge cycle, and the operation or performance of nozzle assembly 302 and hydration system 300 in general.

Notably, discharge nozzle 304 and hydraulic cylinder 320 may be designed to provide a desired volume of spray having ideal droplet size and dispersion for a given application. In this regard, for example, the orifice size of the discharge nozzle 304 may be selected to ensure the ideal atomization, spray pattern, and other spray features for a given pressure. Similarly, the size of cylindrical chamber 328 and piston 330 may be designed to ensure an optimum volume is discharge during the hydration cycle. For example, according to an exemplary embodiment, hydraulic cylinder 320 may define a spray volume that is substantially equivalent to the total volume of cylindrical chamber 328 minus the volume occupied by piston 330. According to exemplary embodiment, the spray volume is equivalent to a desired hydration volume for a single hydration cycle of gardening appliance 100. In other words, the piston size and cylinder length can be designed to ensure the total desired misting cycle volume can be achieved via a single action of the piston and actuator. Thus, for example, when cylindrical chamber 328 is fully charged with a nutrient mixture 308 and when piston makes a full-length stroke from the fully retracted position to the fully extended position, hydraulic cylinder 320 may be substantially empty of all nutrient mixture which is discharged through discharge nozzle 304 to perform a single hydration cycle.

Although nozzle assembly 302 is described herein as facilitating a single stroke hydration cycle, it should be appreciated that according to alternative embodiments, nozzle assembly 302 may utilize partial strokes or multiple strokes of piston 330 to facilitate a hydration process and/or the recharge and discharge processes. For example, the volume of cylindrical chamber 328 may be oversized compared to the volume of a maximum hydration cycle. Oversizing (for instance, perhaps by a factor of two, three, or greater) would allow for small delays in pressure buildup (whether that be due to air pockets or due to the compressibility of water). Further, the desired hydration volume may vary depending on the number of plants and the stages of growth. Thus, according to such an embodiment, actuator 334 may only initiate a partial stroke, thereby discharging less than the full volume of nutrient mixture 308 contained within cylindrical chamber 328.

In addition, it should be appreciated that the actuation speed of actuator 334 may vary in order to improve the hydration process. In this regard, the actuation speed may vary to ensure the desired nozzle pressure and volumetric flow rate are reached. For example, according to the illustrated embodiment, the discharge operation may last less than about 20 seconds, less than about 10 seconds, less than about 5 seconds, less about 2 seconds, less than about 1 second, or less. Other variations and modifications to hydration assembly 300 and nozzle assembly 302 are possible and within the scope of the present subject matter.

The systems and methods described above provide an improved nozzle assembly 302 for directing a hydrating flow or mist of nutrient mixture 310 onto plants 124 within gardening appliance 100. In this regard, for example, nozzle assembly 302 is a plunger or piston operated system that may use a single stroke of the piston to facilitate a single misting cycle. In this regard, for example, a single backstroke may charge a hydraulic cylinder with nutrient mixture sufficient to facilitate a single misting cycle while the forward stroke generates sufficient pressure to create an ideal mist that is discharged from a discharge nozzle. Notably, such a solution creates a more consistent discharge pressures with lower noise and less required power relative to conventional pump and accumulator solutions. Specifically, for example, nozzle assembly 302 is only active during the charge or discharge cycle, whereas a pump must repeatedly re-pressurize an accumulator to maintain a suitable but still oscillating discharge pressure. As a result, the presently disclosed nozzle assembly 302 provides a consistent, high quality misting cycle with constant discharge volumes, droplet sizes, spray pressures, etc. As a result, plants 124 in gardening appliance 100 may better absorb or take in the nutrient mixture 308 discharged from nozzle assembly 302. Moreover, nozzle assembly 302 requires less space than conventional pump and accumulator solutions and has fewer components which are prone to failure, thus reducing maintenance costs. Although an exemplary nozzle assembly 302 is described herein for the purpose of explaining aspects of the present subject matter, it should be appreciated that variations and modifications may be made to nozzle assembly 302 while remaining within the scope of the present subject matter.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A gardening appliance, comprising:
a liner positioned within a cabinet and defining a grow chamber;
a grow module mounted within the liner and defining a pod aperture, the pod aperture being configured for receiving a plant pod;
a mixing tank containing a nutrient mixture; and
a nozzle assembly for selectively spraying the nutrient mixture into the grow chamber, the nozzle assembly comprising:
a discharge nozzle positioned within the grow chamber;
a hydraulic cylinder comprising an intake in fluid communication with the mixing tank and a discharge port in fluid communication with the discharge nozzle; and
an actuator for selectively actuating the hydraulic cylinder to spray the nutrient mixture out of the discharge nozzle.

2. The gardening appliance of claim 1, wherein the hydraulic cylinder comprises:
a barrel defining a cylindrical chamber; and
a piston slidably mounted within the cylindrical chamber, the actuator being configured for sliding the piston toward a retracted position to recharge the cylindrical chamber with the nutrient mixture and toward an extended position to discharge the nutrient mixture through the discharge nozzle.

3. The gardening appliance of claim 2, wherein the cylindrical chamber defines a spray volume greater than a desired hydration volume.

4. The gardening appliance of claim 2, wherein the nozzle assembly further comprises:
a nozzle check valve configured for preventing flow from the discharge nozzle into the cylindrical chamber during a recharge operation.

5. The gardening appliance of claim 4, wherein the nozzle check valve has a cracking pressure corresponding to a desired nozzle pressure.

6. The gardening appliance of claim 5, wherein the desired nozzle pressure is between 50 and 500 pounds per square inch.

7. The gardening appliance of claim 4, wherein the nozzle assembly further comprises:
a pressure switch positioned between the cylindrical chamber and the discharge nozzle, the pressure switch being configured for triggering when a pressure of the nutrient mixture exceeds a predetermined pressure.

8. The gardening appliance of claim 1, wherein the nozzle assembly further comprises:
an air release valve fluidly coupled to the discharge port for purging air within the nozzle assembly.

9. The gardening appliance of claim 1, wherein the nozzle assembly further comprises:
an intake check valve configured for preventing flow from the hydraulic cylinder through the intake during a discharge operation.

10. The gardening appliance of claim 9, wherein the discharge operation lasts less than 5 seconds.

11. The gardening appliance of claim 1, wherein the discharge nozzle is positioned at a top of the grow module within the root chamber.

12. The gardening appliance of claim 1, wherein the actuator is a solenoid or linear actuator.

13. A nozzle assembly for a gardening appliance, the gardening appliance comprising a grow chamber and a mixing tank containing a nutrient mixture, the nozzle assembly comprising:
a discharge nozzle positioned within the grow chamber;
a hydraulic cylinder comprising an intake in fluid communication with the mixing tank and a discharge port in fluid communication with the discharge nozzle; and
an actuator for selectively actuating the hydraulic cylinder to spray the nutrient mixture out of the discharge nozzle.

14. The nozzle assembly of claim 13, wherein the hydraulic cylinder comprises:
a barrel defining a cylindrical chamber; and
a piston slidably mounted within the cylindrical chamber, the actuator being configured for sliding the piston toward a retracted position to recharge the cylindrical chamber with the nutrient mixture and toward an extended position to discharge the nutrient mixture through the discharge nozzle.

15. The nozzle assembly of claim 14, wherein the cylindrical chamber defines a spray volume greater than a desired hydration volume.

16. The nozzle assembly of claim 14, further comprising:
a nozzle check valve configured for preventing flow from the discharge nozzle into the cylindrical chamber during a recharge operation.

17. The nozzle assembly of claim 16, wherein the nozzle check valve has a cracking pressure corresponding to a desired nozzle pressure.

18. The nozzle assembly of claim 16, further comprising:
a pressure switch positioned between the cylindrical chamber and the discharge nozzle, the pressure switch being configured for triggering when a pressure of the nutrient mixture exceeds a predetermined pressure.

19. The nozzle assembly of claim 13, further comprising:
an air release valve fluidly coupled to the discharge port for purging air within the nozzle assembly.

20. The nozzle assembly of claim 13, further comprising:
an intake check valve configured for preventing flow from the hydraulic cylinder through the intake during a discharge operation.
